(19) United States
(12) Patent Application Publication
(10) Pub. No.: US 2021/0185604 A1
(43) Pub. Date: Jun. 17, 2021

(54) WIRELESS COMMUNICATION APPARATUS AND COMMUNICATION CONTROL METHOD

(71) Applicant: Sony Corporation, Tokyo (JP)

(72) Inventor: Hiroaki TAKANO, Tokyo (JP)

(73) Assignee: Sony Corporation, Tokyo (JP)

(21) Appl. No.: 17/254,868

(22) PCT Filed: Jul. 31, 2019
(86) PCT No.: PCT/JP2019/030023

§ 371 Date: Dec. 22, 2020

(30) Foreign Application Priority Data
Aug. 10, 2018 (JP) 2018-151377

(51) Int. Cl. H04W 48/18; H04B 7/06; H04B 7/024; H04W 72/04

(52) U.S. Cl. CPC H04W 48/18; H04W 72/0453; H04B 7/024; H04B 7/0634

(57) ABSTRACT

Provided is a wireless communication apparatus (100) including a wireless communication unit (110) including antenna elements, a processing unit (142) configured to execute signal processing on partial data of signals output from the antenna elements, preferentially to other data, and an output unit (160) configured to output the processed data to an apparatus on a core network side.

### TECHNICAL FIELD

The present disclosure relates to a wireless communication apparatus and a communication control method.

### BACKGROUND ART

Nowadays, as a configuration of a base station system that provides a wireless service, a separated base station having a configuration in which a base band processing unit (BBU; Base Band Unit) that processes a base band signal, and a wireless unit (RRH; Remote Radio Head) that transmits and receives radiowaves to and from antennas are separated has become common. Examples of documents that disclose such a separated base station include Patent Documents 1 and 2.

### CITATION LIST

### Patent Document

### Patent Document 1: Japanese Patent Application Laid-Open No. 2018-14697

### Patent Document 2: Japanese Patent Application Laid-Open No. 2018-23035

### SUMMARY OF THE INVENTION

### Problems to be Solved by the Invention

In a case where a simple configuration in which a BBU is arranged in a cloud base on a network, and an RRH includes an antenna, an RF circuit, and an AD/DA converter is employed from among configurations of such a separated base station, how processing latency of data is suppressed becomes important.

In view of the foregoing, the present disclosure proposes a wireless communication apparatus and a communication control method that are novel and improved, and can efficiently suppress processing latency of data in a configuration of a separated base station in which a BBU is arranged in a cloud base on a network.

### Solutions to Problems

According to the present disclosure, a wireless communication apparatus including a wireless communication unit including antenna elements, a processing unit configured to execute signal processing on partial data of signals output from the antenna elements, preferentially to other data, and an output unit configured to output the processed data to an apparatus on a core network side is provided.

Furthermore, according to the present disclosure, a wireless communication apparatus including a reception unit configured to receive information regarding partial data to be preferentially processed by the wireless communication apparatus, from a communication partner wireless communication apparatus, and a processing unit configured to select a component carrier on the basis of the information regarding the partial data is provided.

Furthermore, according to the present disclosure, a communication control method including executing signal processing on partial data of signals output from antenna elements, preferentially to other data; and outputting the processed data to an apparatus on a core network side is provided.

Furthermore, according to the present disclosure, a communication control method including receiving information regarding partial data to be preferentially processed by the wireless communication apparatus, from a communication partner wireless communication apparatus, and selecting a component carrier on the basis of the received information regarding the partial data is provided.

### Effects of the Invention

As described above, according to the present disclosure, a wireless communication apparatus and a communication control method that are novel and improved, and can efficiently suppress processing latency of data in a configuration of a separated base station in which a BBU is arranged in a cloud base on a network can be provided.

Note that the above-described effect is not always limitative, and together with the above-described effect or in place of the above-described effect, any of the effects described in this specification, or other effects recognized from this specification may be caused.

### BRIEF DESCRIPTION OF DRAWINGS

FIG. 1 is an explanatory diagram illustrating a schematic configuration of an RAN.

FIG. 2 is an explanatory diagram illustrating a schematic configuration of an NR.

FIG. 3 is an explanatory diagram illustrating an arrangement example of an RRH and a BBU.

FIG. 4 is an explanatory diagram illustrating an Analogue/Digital Hybrid Antenna architecture.

FIG. 5 is an explanatory diagram illustrating that data of a plurality of RRH is consolidated by a switch anterior to a BBU.

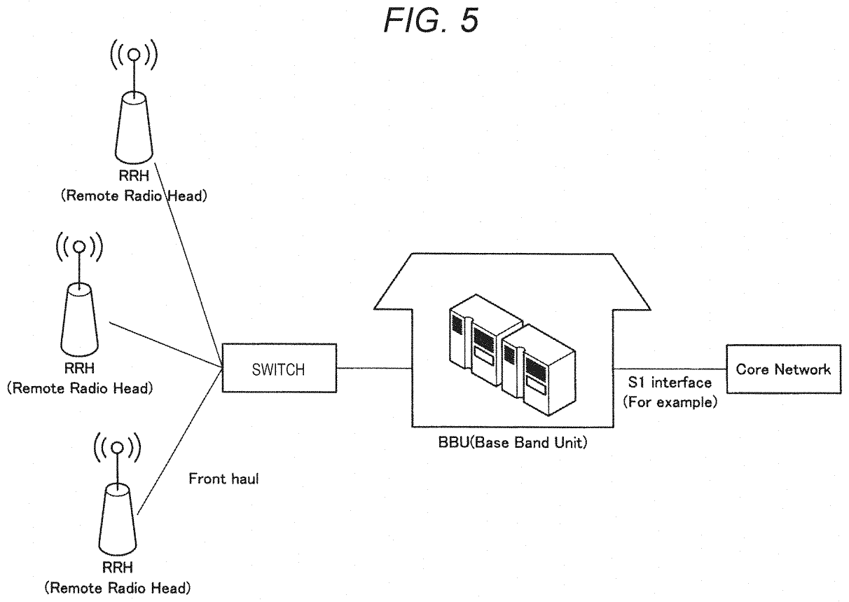

FIG. 6 is an explanatory diagram illustrating a format of a data container of an I/Q.

FIG. 7 is an explanatory diagram illustrating a configuration example of an RRH according to an embodiment of the present disclosure.

FIG. 8 is an explanatory diagram illustrating an example of storing AD-converted data as two-dimensional complex data.

FIG. 9 is an explanatory diagram illustrating configurations of normal RRH and BBU.

FIG. 10 is an explanatory diagram illustrating configurations of an RRH and a BBU according to the present embodiment.

FIG. 11 is an explanatory diagram illustrating a functional configuration example of an RRH 100 and a BBU 200 according to an embodiment of the present disclosure.

FIG. 12 is an explanatory diagram illustrating that three CCs among ten CCs are CCS with short latency.

FIG. 13 is a flowchart illustrating a conventional connection procedure.

FIG. 14 is a flowchart illustrating an operation of the RRH 100, the BBU 200, an MME, and a terminal according to the present embodiment.

FIG. 15 is a flowchart illustrating an example of a procedure in a case where a function of a core network necessary for an attach procedure is included in the RRH.

FIG. 16 is an explanatory diagram illustrating an example in which four BWPs are included in one component carrier.

FIG. 17 is an explanatory diagram illustrating a configuration example of a base station according to the present embodiment.

FIG. 18 is an explanatory diagram illustrating a configuration example of a base station according to the present embodiment.

FIG. 19 is an explanatory diagram illustrating an example of an enable signal to be transmitted from a BBU to an RRH.

FIG. 20 is an explanatory diagram illustrating an arrangement example of an RRH and a BBU.

FIG. 21 is a flowchart illustrating an operation example of a base station according to an embodiment of the present disclosure.

FIG. 22 is an explanatory diagram describing an example of a configuration of a terminal apparatus according to an embodiment of the present disclosure.

### MODE FOR CARRYING OUT THE INVENTION

Hereinafter, a preferred embodiment of the present disclosure will be described in detail with reference to the attached drawings. Note that, in this specification and the drawings, the redundant description will be omitted by allocating the same reference numerals to the components having substantially the same functional configuration.

Note that the description will be given in the following order.

1. Embodiment of Present Disclosure
1.1. Background
1.2. Description of Embodiment

2. Conclusion

<1. Embodiment of Present Disclosure>

[1.1. Background]

Before describing an embodiment of the present disclosure in detail, the background of an embodiment of the present disclosure will be described.

As described above, a separated base station having a configuration in which a base band processing unit (BBU) that processes a base band signal, and a wireless unit (RRH) that transmits and receives radiowaves to and from antennas are separated has become common. Here, as an interface between the base band processing unit and the wireless unit, for example, a general-purpose interface complying with a Common Public Radio Interface (CPRI) standard or the like is defined. In the CPRI standard, the base band processing unit is also called a wireless control apparatus (Radio Equipment Controller: REC) and the wireless unit is also called a wireless apparatus (Radio Equipment: RE). Furthermore, in the CPRI standard, user data (also called U-plane data, digital base band signal, data signal) transmitted between the wireless control apparatus and the wireless apparatus is also called In-phase and Quadrature (IQ) data.

(New Radio Access and New Core)

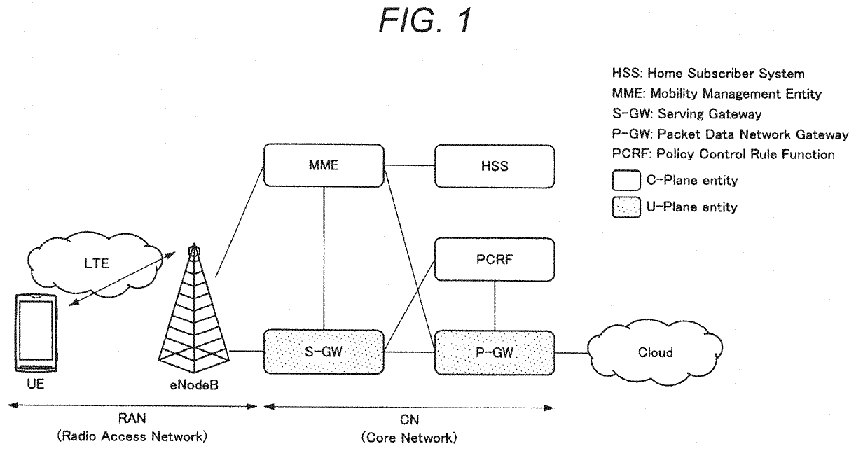

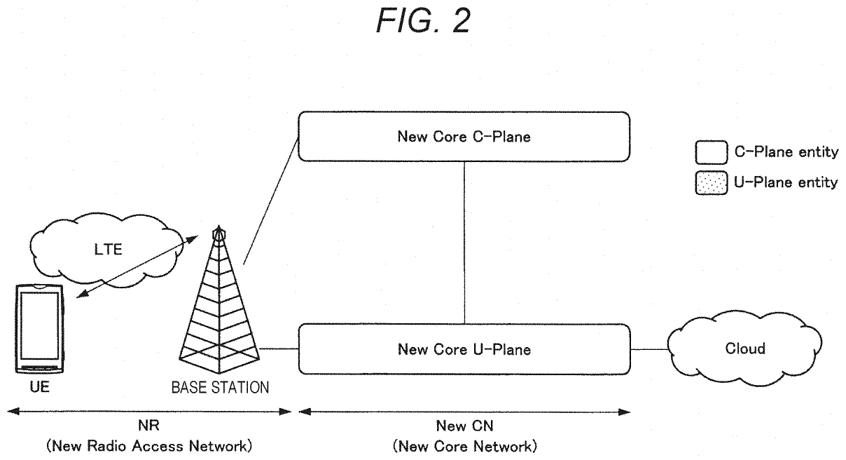

In the Third Generation Partnership Project (3GPP), New Radio Access (NR) is considered as a successor of a Radio Access Network (RAN) called Long Term Evolution (LTE). FIG. 1 is an explanatory diagram illustrating a schematic configuration of an RAN. FIG. 2 is an explanatory diagram illustrating a schematic configuration of an NR. Furthermore, New Core is considered as a successor of a core network (CN) called an Evolved Packet Core (EPC).

The feature of the NR is to implement high-speed high-capacity communication using a frequency band of 6 GHz or more and up to 100 GHz. A cellular system includes an RAN and a CN. An RAN portion requires most of the cost of the cellular system. This is because several thousands of RANs are installed, which is extremely large in number as compared with CNs. Several tens of CNs are considered to be installed.

(C-RAN)

A base station requires extremely high calculator cost. However, the number of terminals connecting to each base station varies with time. Not all the base stations always use the maximum value of processing capacity. Thus, if the capacity of calculators of base stations can be shared between a plurality of base stations, it becomes possible to decrease the cost of calculators. Furthermore, it is also possible to reduce power consumed in base stations.

The base station includes an analogue portion including an antenna and an RF circuit, an AD/DA converter arranged at the boundary between the analogue portion and a digital portion, and the digital portion that performs complicated digital signal processing. The digital portion can include a Field Programmable Gate Array (FPGA) or a Digital Signal Processor (DSP), but can be processed by a general-purpose calculator.

A C-RAN (Cloud RAN, Centralized RAN, Clean RAN) is an RAN that can process an enormous calculation amount using a server on a network side.

As described above, a case where functions of a base station are separated into two corresponding to an RRH and a BBU will be considered. For example, an antenna, an RF circuit, and an AD/DA converter are arranged in the RRH, and a digital signal processing portion of PHY/MAC of remaining digital units is arranged in the BBU. The C-RAN processes the BBU portion on a cloud.

Because BBUs of a plurality of base stations can be processed by a common server as for the BBU portion arranged on a cloud, the cost of base stations can be decreased. Because it is sufficient that a general-purpose processing server adapted to a processing amount required for a plurality of base stations is prepared, low cost can be realized.

On the other hand, base stations need to be arranged in many locations. In particular, if a frequency to be used becomes higher, a range covered by one base station becomes narrower, and an extremely large number of base stations are required to be arranged. Therefore, further cost saving of an RRH is seriously demanded.

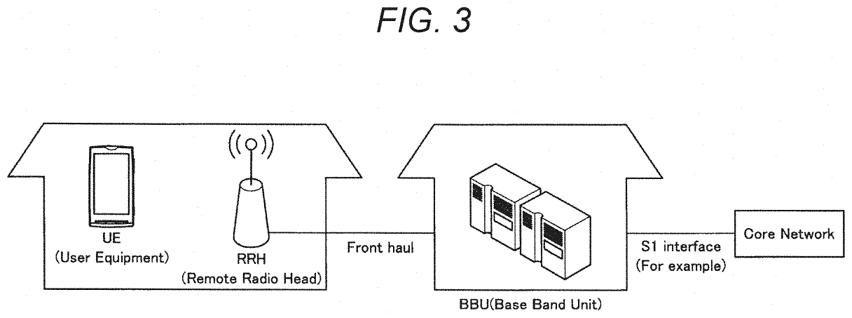

From the above points, it can be said that a future cellular network is high likely to include an RRH and a BBU of a C-RAN. FIG. 3 illustrates a conceptual diagram in which a BBU is arranged in a server in the home, and an RRH is connected to a portion of an outdoor antenna unit via a front haul being an optical fiber. The BBU is connected with a core network via an optical fiber serving as a back haul. It should be appreciated that the optical fiber is a typical example, and can be replaced with an ADSL or wireless communication.

Table 1 indicates an example of a function of an RRH, and Table 2 indicates an example of a function of a BBU.

TABLE 1
(Table 1: Example of Function of RRH)

| Uplink | Downlink |
|---|---|
| A/D | D/A |
| I/Q data transmitter | I/Q data receiver |
| E/O conversion | O/E conversion |

TABLE 2
(Table 2: Example of Function of BBU)

| Uplink | Downlink |
|---|---|
| O/E conversion | E/O conversion |
| Cyclic prefix removal | Cyclic prefix insertion |
| FFT | IFFT |
| Chanel de-coding | Channel coding |
| Modulation | De-Modulation |
| | Mac scheduling |

(Front Haul and Back Haul)

As illustrated in FIG. 3, a front haul is provided between the RRH and the BBU, and a back haul is provided between the BBU and an S-GW. The front haul is an interface that has become necessary by separating the base station into the RRH and the BBU. While the front haul is sometimes wirelessly connected, the front haul is generally connected via a wired optical interface.

A communication speed generally required of a conventional front haul is about 10 Gbps. Via the front haul, AD-converted data or DA-converted data needs to be transferred, and data needs to be transferred while being at a signal point of an I/Q axis. Therefore, a large data transfer speed is required of an interface of the front haul.

On the other hand, data flowing via the interface of the back haul is a bit sequence determined from a signal point of the I/Q axis. Because an information amount of data flowing via the interface of the back haul becomes a bit sequence comprehensively determined from signals of a plurality of antennas, the information amount becomes several Gbps at most. The back haul serves as an interface with a gateway (S-GW as a term of EPC) bundling a plurality of base stations.

Thus, because a switch anterior to the S-GW needs to bundle information from several tens to several thousands of base stations, processing capacity of several terabits/s is required. Thus, although data processing in a core network is not easy, a processing speed can be reduced by arranging the BBU on the cloud side and performing traffic offload. On the other hand, in the current condition, the front haul requires a speed of about 10 Gbps for one line. Thus, the front haul becomes a critical point.

(Data Transfer Speed Required of Front Haul)

A data transfer speed required of the front haul depends on the number of AD/DA converters. Normally, an AD converter often requires a larger bit depth than a DA converter. For example, when an AD converter represents a waveform in 10 bits, a DA converter represents a waveform in eight bits. As a matter of course, if a bit depth of an AD converter increases, a data transfer speed required of the front haul increases.

Furthermore, a sampling rate of an AD converter affects a data transfer speed. When a frequency bandwidth used in the operation in an RAN is 20 MHz, an AD converter with 40 Msps (sampling per second) becomes necessary. This is attributed to a sampling theorem defining that sampling needs to be performed at a double frequency of a handled frequency. Because a wide frequency bandwidth such as 1 GHz is assumed in the NR of 5G, a sampling frequency required of an AD converter becomes 2 Gsps.

An element affecting next is the number of component carriers. 32 component careers (CC) with 1-GHz width can be used at most. This is called carrier aggregation. If the number of component carriers increases, burden on the front haul accordingly increases.

An element affecting next is the number of AD converters. In a case where the number of antennas is 30, for example, 30 AD converters are required.

Table 3 lists elements affecting a transfer speed of a front haul.

TABLE 3
(Table 3: Element Affecting Transfer Speed of Front Haul)

| | Typical numerical | |
|---|---|---|
| Element | value | Description |
| Bit depth of AD | 8 bit-12 bit | |
| converter | | |
| Sampling rate of | 20 Msps-2 Gsps | Depending on bandwidth |
| AD converter | | 10 MHz-1 GHz |
| | | Sampling in equal to or |
| | | larger than double of |
| | | bandwidth is required |
| Number of | 1-32 | Might increase in the future |
| Component | | |
| Carriers | | |
| Number of AD | 1-64 | Attributed to the number of |
| converters required | | antennas. 32 AD converters |
| for ICC | | are required when the number |
| | | of antennas is 256, the |
| | | number of analogue beams is |
| | | 8, and the number of |
| | | branches is 32. |

According to Table 3, a required transfer speed of the front haul becomes 12×2G×32×32=24 Tbps at most.

(Hybrid Antenna Architecture)

For example, in a case where a base station includes 256 antennas, a DA/AD converter handling all of the antennas is required in some cases. This is called Full Digital Antenna architecture. In this case, because it becomes possible to adjust amplitudes and phases of all the antennas in a digital domain, the freedom degree of directivity of antenna becomes largest. Different antenna directivities can be used for the respective different frequencies.

However, this method increases the number of RFs, and a large number of AD/DA converters is also required. Moreover, a signal processing amount in a digital domain also increases.

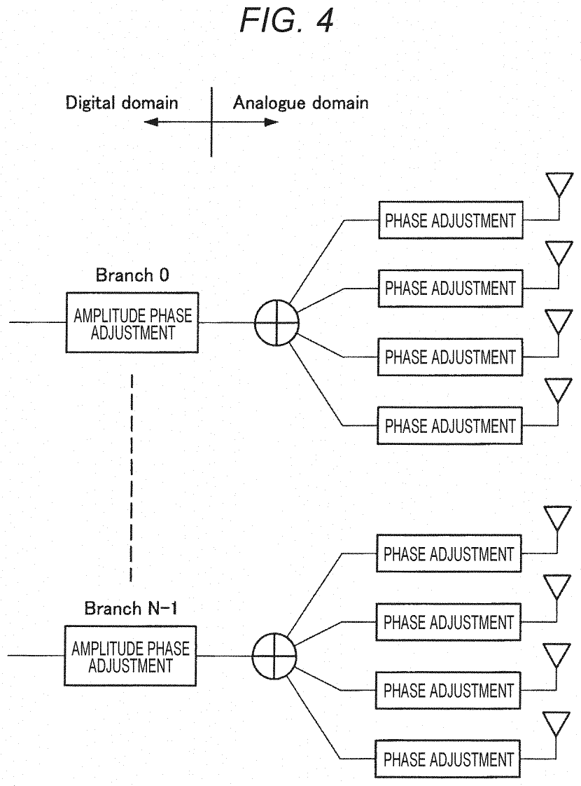

The Analogue/Digital Hybrid Antenna architecture has been conceived in view of the foregoing. As illustrated in FIG. 4, the Analogue/Digital Hybrid Antenna architecture is an architecture of reducing the number of branches that can digitally adjust both amplitude and phase by connecting a plurality of antennas via a phase shifter that can adjust only a phase in an analogue unit. From the aspect of the influence on the front haul, it is desirable to use the Hybrid Antenna architecture that can reduce the number of branches.

(Various Use Cases)

Here, Table 4 lists a throughput of a front haul required for each use case in consideration of the above-described Hybrid Antenna architecture.

TABLE 4
(Table 4: Throughput Example of Front Haul)

| | | | | | Bit depth of | | Throughput | |
|---|---|---|---|---|---|---|---|---|
| | | | | | AD converter | AD | required | |
| Use | Frequency | | Number | | (required | converter | for front | |
| case | bandwidth | | of CCs | Antenna architecture | for each I/Q) | sampling | haul | |
| 1 | 10 | MHz | 2 | 2Digital = 2 | 10 bit | 20M | 1.6 | Gbps |
| 2 | 10 | MHz | 5 | 8Digital*8Analogue = 64 | 10 bit | 20M | 16 | Gbps |
| 3 | 10 | MHz | 5 | 16Digital*8Analogue = 128 | 10 bit | 20M | 32 | Gbps |
| 4 | 100 | MHz | 10 | 32Digital*8Analogue = 256 | 10 bit | 200M | 1280 | Gbps |
| 5 | 100 | MHz | 32 | 32Digital*8Analogue = 256 | 10 bit | 200M | 4 | Tbps |
| 6 | 1 | GHz | 10 | 16Digital*8Analogue = 128 | 10 bit | 2 G | 6.4 | Tbps |
| 7 | 1 | GHz | 32 | 32Digital*32Analogue = 1024 | 10 bit | 2 G | 40 | Tbps |
| 8 | 1.4 | MHz | 1 | 1 | 10 bit | 2.8M | 56 Mbps ADSL | |
| (Cat- | | | | | | | is also | |
| M) | | | | | | | applicable | |
| 9 | 100 | MHz | 5 | 32Digital*8Analogue = 256 | 10 bit | 200M | 640 | GHZ |
| | | | | (If analogue antenna | | | | |
| | | | | processing is | | | | |
| | | | | performed in RRH) | | | | |

The speed of a normal Ethernet (registered trademark) cable is about 1 Gbps. Furthermore, an optical fiber is laid to the home, but the maximum speed as a service is 1 Gbps. This is because, when an Ethernet (registered trademark) cable is connected, a speed of 1 Gbps or more might fail to be effectively utilized.

In the current condition, an allowable speed of the front haul inside a home or an office can be said to be about 1 Gbps. Thus, in the current condition, only a use case 1 can realize a C-RAN. As a matter of course, the following technologies can be applied to other use cases.

The capacity of an optical fiber is 10 Gbps in the case of time-division multiplexing, and transfer can be performed at 10 Tbps if wavelength-division multiplexing or multilevel modulation is used. The maximum value of the capacity of an optical fiber actually used for commercial use is considered to be 10 Gbps. Thus, in a case where a dedicated optical fiber is laid to an outdoor RRH, a communication speed that can be used for the front haul is 10 Gbps, and in a case where an RRH is provided inside a home, the communication speed is 1 Gbps. As a matter of course, communication at the speed equal to or higher than the speed is considered to be used in the front haul.

(Common Public Radio Interface (CPRI))

There is a standard of CPRI. Option1is a front haul that can perform transmission at 614.4 Mbit/s, and Option10 is a front haul that can perform transmission at 24.33 Gbit/s. Basically, the standard defines how a synchronization signal is transmitted, and how I/Q data is multiplexed by TDM, and does not define how to reduce a signal to be transmitted.

As a bit sequence itself of I/Q, a bit sequence corresponding to one antenna or one carrier is defined as a bit sequence (AxC container) of I/Q. A bit sequence corresponding to a plurality of antennas or component carriers is obtained by multiplexing this AxC container. Note that the CPRI is not a standard in the 3GPP, but the CPRI is defined to be applicable to the 3GPP. In the future, there is a possibility that the CPRI is utilized for considering the standard of 3GPP and is standardized.

(Received Data and Transmitted Data of Base Station)

In many cases, data received by a base station requires a larger data amount than transmitted data. The present embodiment can be applied to both reception and transmission in a base station, but a technology will be first described using a flow of a signal on the reception side of the base station. This is because the description using processing on the reception side is considered to be important since wireless signal processing generally requires larger signal processing capacity on the reception side, and a C-RAN essentially aims to reduce signal processing on the reception side.

[1.2. Description of Embodiment]

(Format of Data Container of I/Q)

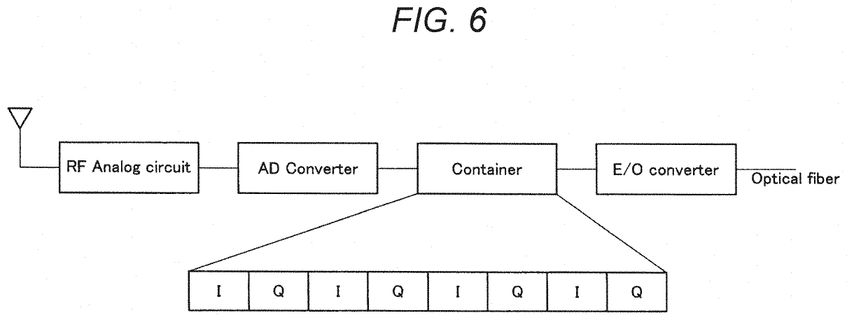

If a bit sequence corresponding to one antenna or one component carrier is defined as a processing-based container, as illustrated in FIG. 6, relationship between different antennas is completely separated. In consideration of performing compression using correlation between data received by different antennas, it is easier to compress information using a compression algorithm when information from a plurality of antennas is stored into one container.

In the present embodiment, the RRH stores information from an AD converter corresponding to a plurality of antenna elements corresponding to one time, into one container. Then, by chronologically arranging the containers, the RRH according to the present embodiment creates a data structure of the front haul. Because correlated signals received by a plurality of antenna elements are stored into the same container by the RRH, the signals can be easily compressed before being stored into the container, which is advantageous. Furthermore, also in the case of processing data on the BBU side of the cloud, it is easier to process information when information from a plurality of antenna elements is delivered at the same time. This is because such a shortcoming that it has been necessary to wait for data from a plurality of antenna elements when antenna signal processing is performed on the BBU side can be overcome.

A two-dimensional array antenna has a configuration in which antenna elements are arranged in a vertical direction and a horizontal direction. An input of radiowaves to antenna elements varies only in phase, and basically the same signal comes. This works out in a case where a signal generation source is sufficiently far as compared with an interval between antenna elements (called far solution approximation).

Thus, information between antenna elements can be compressed using an information compression algorithm. A difference in phase between antennas varies for each signal generation source depending on the direction from which the signal generation source comes, but if a compression algorithm used for compression of a normal moving image is used, for example, compression can be performed in such a manner as to encompass a phase difference between antennas.

In the present embodiment, in a case where antenna elements are two-dimensionally arranged like a two-dimensional array antenna, information regarding I/Q is arranged like pixels of video data while maintaining the two-dimensional structure, and the information regarding I/Q is stored into a container in such a manner as to keep time, that is to say, in such a manner that data at different times become two-dimensional images at different times.

Here, an image does not have the concept of I/Q, but a method that is based on two-dimensional discrete Fourier transform can be used for the compression of an image system. In this case, because input data to two-dimensional discrete Fourier transform can be given using a complex number, two-dimensional complex data is obtained from data in which antennas are two-dimensionally arranged. By taking out low-frequency components after performing two-dimensional Fourier transform on two-dimensional complex data, the compression of data can be performed.

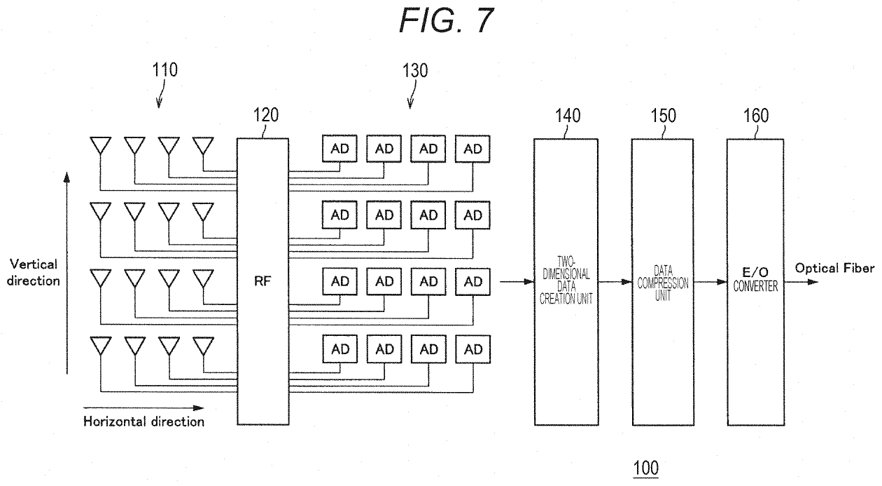

FIG. 7 is an explanatory diagram illustrating a configuration example of an RRH according to an embodiment of the present disclosure. An RRH 100 illustrated in FIG. 7 includes a two-dimensional array antenna 110, an RF circuit 120, an AD converter 130, a two-dimensional data creation unit 140, a data compression unit 150, and an E/O converter 160.

The two-dimensional array antenna 110 is an antenna array in which antennas that receive radiowaves from a terminal serving as a communication partner, and transmit radiowaves to the terminal are arranged in an array. The RF circuit 120 is an analogue circuit that executes reception processing on a signal received by the two-dimensional array antenna 110. The RF circuit 120 may include a mixer, a filter, and an amplifier.

The AD converter 130 is a circuit that converts an analogue signal output by the RF circuit 120, into a digital signal. The two-dimensional data creation unit 140 generates two-dimensional complex data as described later, from data output by the AD converter 130. The data compression unit 150 executes compression processing on the two-dimensional complex data generated by the two-dimensional data creation unit 140. Then, the E/O converter 160 converts an electrical signal into an optical signal for transmitting the converted signal to the BBU from the RRH via an optical fiber.

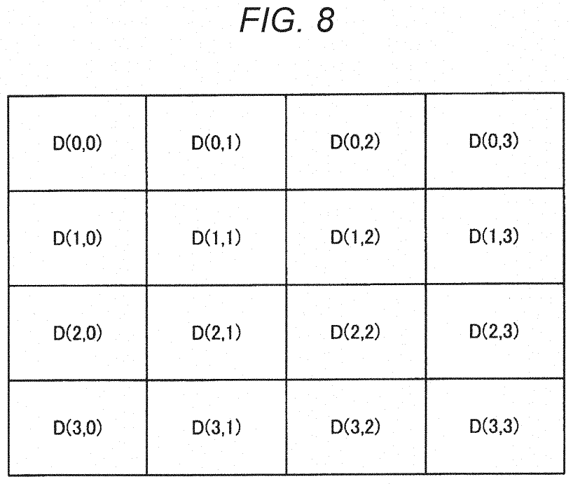

Furthermore, FIG. 8 illustrates an example of storing AD-converted data from two-dimensionally arranged antennas, as two-dimensional complex data by the two-dimensional data creation unit 140. D(i,j) indicates that corresponding data is I/Q data corresponding to i-th data in the vertical direction and j-th data in the horizontal direction.

Because the data in FIG. 8 is data from the two-dimensional antennas at one time, series of data is obtained by chronologically arranging the data in FIG. 8. A delimiter of a container may be a delimiter as illustrated in FIG. 8, or data may be stored into the container every certain period of time. Here, the certain period of time is based on the time of one sample of an AD converter. Here, an important point lies in that information indicating the numbers of images in the vertical and horizontal directions (4×4 in the example in FIG. 8) is conveyed to a compression algorithm in the data compression unit 150. This becomes an interface between a container block (two-dimensional data creation unit 140) and a compression function (the data compression unit 150). This notification itself may be set as a configuration of a base station or may be defined as a standard.

Note that the number of analogue circuits in one RRH is limited. Therefore, connection between an antenna and an analogue circuit is sometimes changed in one RRH. In this case, because the numbers of antennas in the horizontal direction and the vertical direction of the array antenna also change, the RRH 100 rearranges the container in accordance with the change, and notifies the BBU of the size. Even in a case where connection between an antenna and an analogue circuit is changed in the RRH, in the BBU, compressed data can be decompressed.

A base station for a C-RAN includes an RRH and a BBU. The RRH can be arranged near the terminal. For example, the RRH can be arranged within several tens meters to several hundreds of meters from the terminal. The RRH is connected via an optical fiber with the BBU arranged on a server in a station building where abundant calculator resources exist. A distance between the RRH and the BBU becomes several kilometers to several tens of kilometers depending on the case.

Because data passes through many switches provided between the RRH and the BBU, and transmission latency is also caused by the optical fiber, if the BBU performs signal processing, latency tends to increase as compared with a case where the RRH performs all pieces of processing.

In wireless communication, there has been recently an increasing number of use cases in which a latency amount of 1 ns (or 1 ns or less) is required. Examples of such use cases include a use case where a real time property is severely demanded, such as the control of a vehicle, a drone (flight vehicle), or a robot. It is therefore demanded to shorten processing latency of a base station having a configuration including an RRH and a BBU, in a case where the BBU is arranged on a server in a station building where abundant calculator resources exist.

A base station including an RRH and a BBU can perform transmission and reception of a plurality of component carriers (CCs). For example, a base station can perform a service while bundling five component carriers with 20 MHz. In this manner, performing transmission and reception while bundling a plurality of component carriers is called carrier aggregation (CA).

In the carrier aggregation, there are a Primary Component Carrier (PCC) and a Secondary Component Carrier (SCC). The PCC is used for performing an important signaling procedure called NAS signaling performed when a User Equipment (UE; terminal) starts communication with a control station such as Mobility Management Entity (MME) of a core network. For reducing latency generated when the UE connects to a network at the time of carrier aggregation, it is important to reduce latency generated when the PCC is used.

In view of the foregoing, the present embodiment is characterized in that, as for a part of component carriers such as a PCC, for example, functions to be processed by the BBU are also arranged on the RRH side and processed on the RRH side, and the functions of the BBU of the remaining SCCs are performed by the BBU arranged on a cloud. By including the functions to be processed by the BBU, and performing the processing of the PCC, the RRH can shorten latency generated at the time of carrier aggregation.

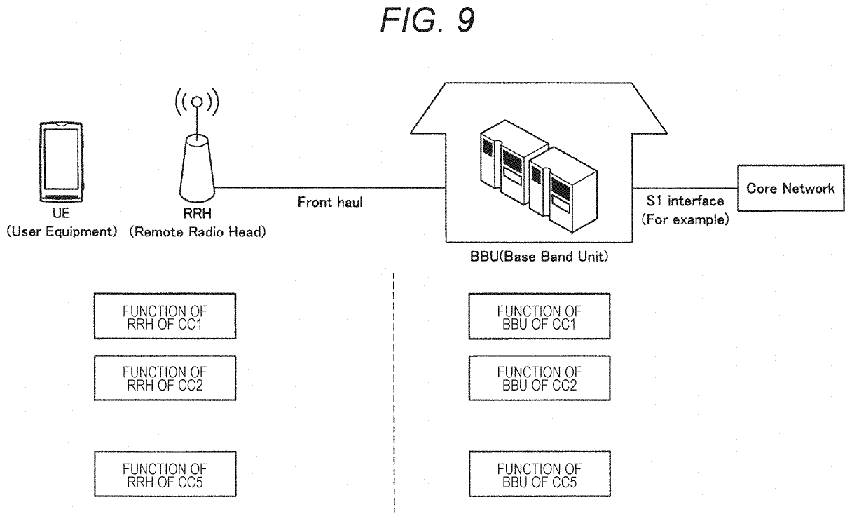

FIG. 9 is an explanatory diagram illustrating configurations of normal RRH and BBU. More specifically, in the configuration in FIG. 9, AD-converted I/Q data corresponding to all of CC1, CC2, . . . , and CC5 are transmitted from an RRH to a BBU, and functions of the BBU of all of the CC1, CC2, . . . , and CC5 are performed by the BBU.

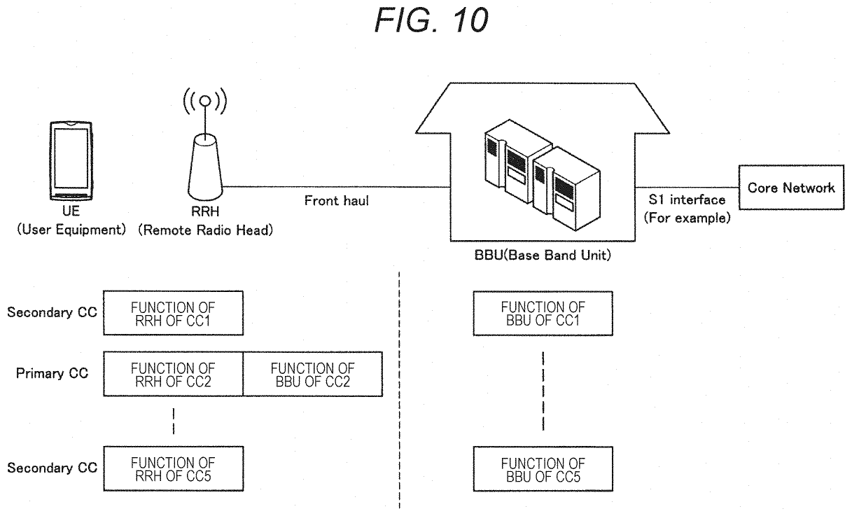

On the other hand, FIG. 10 is an explanatory diagram illustrating configurations of an RRH and a BBU according to the present embodiment. In the configuration in FIG. 10, when a PCC of a specific UE is CC2, the function of the RRH and the function of the BBU of the CC2 for the UE are both arranged in the RRH, and processing is performed by the RRH.

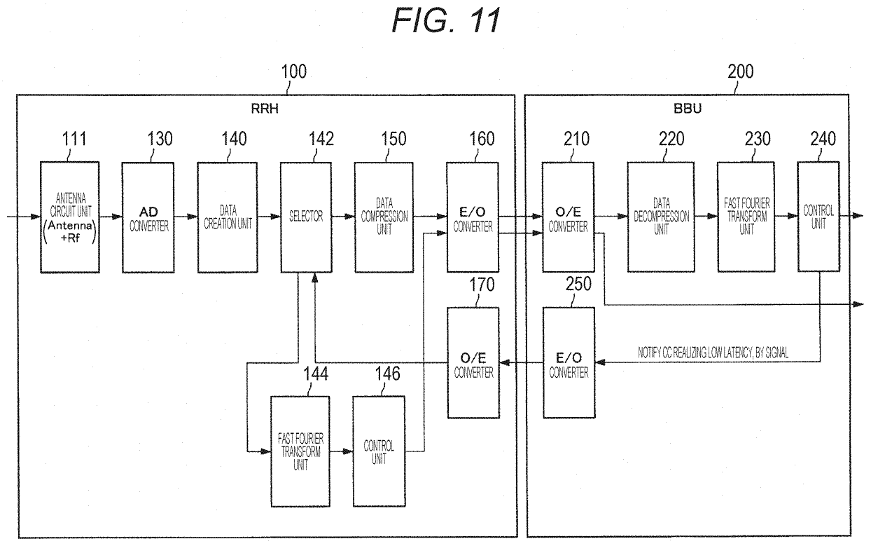

FIG. 11 is an explanatory diagram illustrating a functional configuration example of an RRH 100 and a BBU 200 according to an embodiment of the present disclosure.

The RRH 100 illustrated in FIG. 11 includes an antenna circuit unit 111, an AD converter 130, a data creation unit 140, a selector 142, a fast Fourier transform unit 144, a control unit 146, a data compression unit 150, an E/O converter 160, and an O/E converter 170.

The BBU 200 illustrated in FIG. 11 includes an O/E converter 210, a data decompression unit 220, a fast Fourier transform unit 230, and a control unit 240.

The antenna circuit unit 111 includes, for example, a two-dimensional array antenna and an analogue circuit (RF circuit) that executes reception processing on signals received by the array antenna. The array antenna is an antenna array in which antennas that receive radiowaves from a terminal serving as a communication partner, and transmit radiowaves to the terminal are arranged in an array.

The AD converter 130 is a circuit that converts an analogue signal output by the RF circuit, into a digital signal. The data creation unit 140 generates an I/Q data string from data output by the AD converter 130. The data compression unit 150 executes compression processing on the I/Q data string generated by the data creation unit 140. Then, the E/O converter 160 converts an electrical signal into an optical signal for transmitting the converted signal to the BBU 200 from the RRH via an optical fiber. The O/E converter 170 acquires the data transmitted from the BBU 200. Furthermore, the fast Fourier transform unit 144 executes fast Fourier transform processing on the data generated by the data creation unit 140. The control unit 146 performs, for example, decoding of data subjected to fast Fourier transform processing executed by the fast Fourier transform unit 144.

The O/E converter 210 converts an optical signal transmitted from the RRH 100 via the optical fiber, into an electrical signal. The data decompression unit 220 decompresses data compressed in the RRH 100 and restores data. The fast Fourier transform unit 230 executes fast Fourier transform processing on the data restored by the data decompression unit 220. The control unit 240 executes basic functions of the BBU 200. Examples of basic functions of the BBU 200 include data decoding, scheduling processing, and QOS control.

Among the above functions, a function that requires time in processing is fast Fourier transform processing executed by the fast Fourier transform unit 230. In view of the foregoing, if a CC that executes fast Fourier transform processing is arranged not in the BBU 200 but in the RRH 100 in such a manner that fast Fourier transform processing can be executed by the fast Fourier transform unit 144 in the RRH 100, speed-up of data processing can be achieved.

Here, as the configuration of the RRH 100, as illustrated in FIG. 11, connection between a CC and the BBU can be set by the selector 142. As for the switching of the connection, the O/E converter 170 receives an instruction from the BBU 200 arranged on the cloud side. By having such a configuration, the speed of the processing of the PCC of the UE becomes faster than that of the processing of other CCs.

The PCC varies for each UE. Thus, it is undesirable to determine that processing of a CC at a certain fixed frequency is processed by both of an RRH and a BBU. This is because a PCC varies for each UE. Thus, unlike an existing base station, in the present embodiment, a base station preliminary notifies a UE that a latency time of a CC is short.

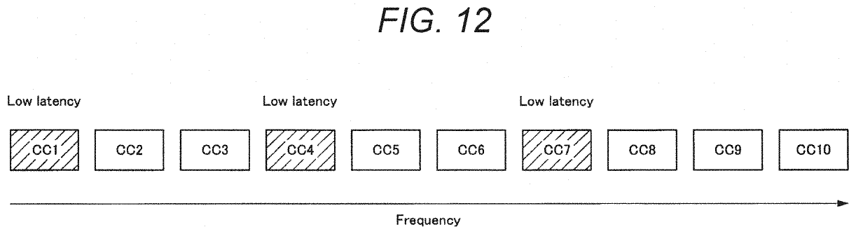

FIG. 12 is an explanatory diagram illustrating that, among ten CCs from CC1 to CC10, three CC1, CC4, and CC7 are CCs with short latency. Then, the base station notifies information regarding CCs with short latency, to the UE as system information. The UE selects a PCC from among the three CC1, CC4, and CC7 with short latency. Therefore, all UEs can select any of the three CC1, CC4, and CC7 as a PCC.

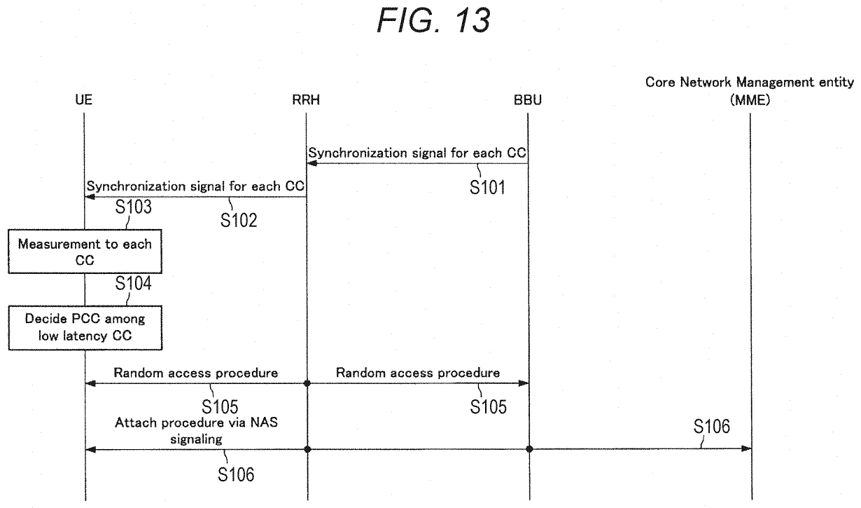

In any case, as illustrated in FIG. 11, it is necessary to designate a CC of which processing to be performed by the BBU needs to be performed on the RRH side, from the BBU on the cloud side to the RRH. FIG. 13 illustrates a connection procedure in a conventional case. A black circle in FIG. 13 indicates that information needs to be received and transferred. A portion of an arrow indicates a transmission and reception point. FIG. 13 illustrates an example in which a random access procedure is exchanged with a BBU arranged on a cloud.

First of all, the BBU generates a synchronization signal for all component carriers, and transfers the synchronization signal to the RRH (Step S101). The RRH transmits the synchronization signal received from the BBU, to the terminal (Step S102).

If the terminal receives the synchronization signal from the RRH, the terminal executes measurement to each component carrier (Step S103). Then, as a result of the measurement, the terminal decides a primary component carrier among low latency component carriers (Step S104).

Subsequently, a random access procedure is executed between the terminal, the RRH, and the BBU (Step S105), and then a connection procedure (attach procedure) is executed between the terminal, the RRH, the BBU, and the MME (Step S106). Here, in the conventional procedure, at the time of the random access procedure, the RRH needs to transfer data from the UE to the BBU. Furthermore, in executing the connection procedure, data from the terminal is transmitted to the MME via the RRH and the BBU.

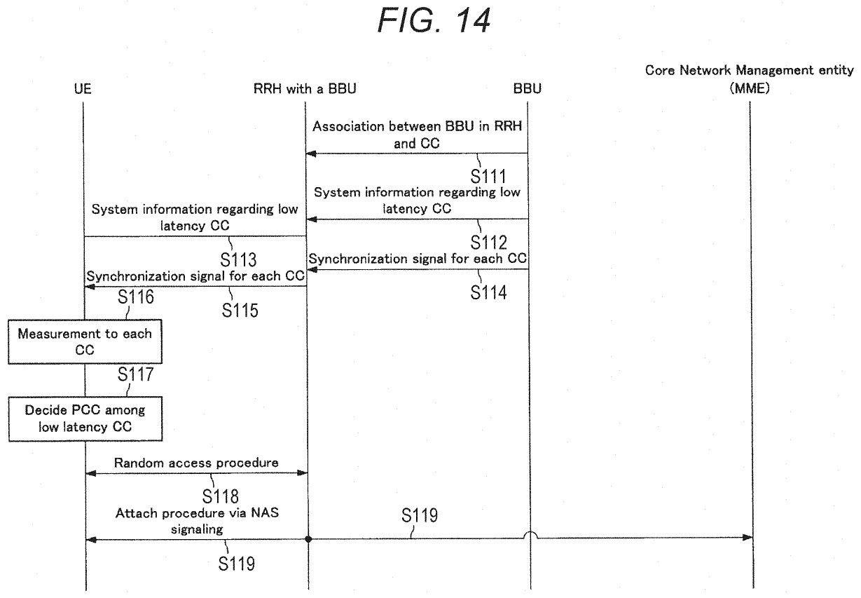

FIG. 14 is a flowchart illustrating an operation of the RRH 100, the BBU 200, an MME, and a terminal according to the present embodiment. The BBU 200 arranged on the cloud performs control by notifying association regarding a CC among a plurality of CCs to which a function of one BBU included in the RRH is to be connected (Step S111). Then, the BBU 200 transmits system information regarding a low latency CC to the RRH 100 (Step S112).

On the basis of the notification from the BBU 200, the RRH 100 selects, by a selector, data among data of a plurality of CCs that is to be transmitted to the BBU. After that, the RRH 100 provides information indicating a CC that can provide a low latency service for providing the function of the BBU 200 on the RRH 100, to the terminal as information regarding a low latency CC (Step S113).

Thereafter, the BBU 200 generates a synchronization signal for all component carriers, and transfers the synchronization signal to the RRH 100 (Step S114). The RRH 100 transmits the synchronization signal received from the BBU 200, to the UE (Step S115).

If the terminal receives the synchronization signal from the RRH, the terminal executes measurement to each component carrier (Step S116). Then, as a result of the measurement, the UE decides a primary component carrier among low latency component carriers (Step S117).

Here, the terminal can identify a CC that is a low latency CC, on the basis of the notification from the RRH 100. On the basis of the notification from the RRH 100, the terminal can select a low latency CC and perform random access (Step S118). In this case, the RRH can create a response to the random access. Thus, low latency can be realized because a random access signal from the terminal needs not be transferred to the BBU.

Furthermore, also in an attach procedure via NAS signaling that starts after the random access (Step S119), the BBU needs not be used for reception processing of NAS signaling. However, in this case, because it is eventually necessary to transfer a signal to the MME included in the core network arranged in the station building, low latency might fail to be realized in some cases. A method for dealing with this point will be described.

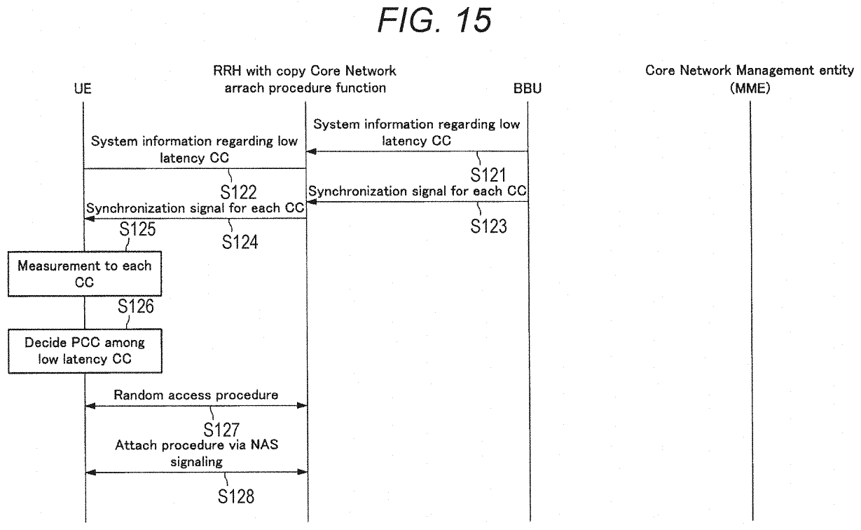

FIG. 15 is a flowchart illustrating an example of a procedure in a case where a function (MME and HSS in the case of LTE) of a core network necessary for an attach procedure is included in the RRH 100. In this manner, by including the function of the core network necessary for an attach procedure, in the RRH, low latency can be realized.

The BBU 200 transmits system information regarding a low latency CC to the RRH 100 (Step S121).

On the basis of the notification from the BBU 200, the RRH 100 selects, by a selector, data among data of a plurality of CCs that is to be transmitted to the BBU. After that, the RRH 100 provides information indicating a CC that can provide a low latency service for providing the function of the BBU 200 on the RRH 100, to the terminal as information regarding a low latency CC (Step S122).

Thereafter, the BBU 200 generates a synchronization signal for all component carriers, and transfers the synchronization signal to the RRH 100 (Step S123). The RRH 100 transmits the synchronization signal received from the BBU 200, to the UE (Step S124).

If the terminal receives the synchronization signal from the RRH, the terminal executes measurement to each component carrier (Step S125). Then, as a result of the measurement, the UE decides a primary component carrier among low latency component carriers (Step S126).

Here, the terminal can identify a CC that is a low latency CC, on the basis of the notification from the RRH 100. On the basis of the notification from the RRH 100, the terminal can select a low latency CC and perform random access (Step S127). In this case, the RRH can create a response to the random access. Thus, low latency can be realized because a random access signal from the terminal needs not be transferred to the BBU.

Furthermore, also in an attach procedure via NAS signaling that starts after the random access (Step S128), the BBU needs not be used for reception processing of NAS signaling. Moreover, in this case, because a function (MME and HSS in the case of LTE) of a core network necessary for an attach procedure is included in the RRH 100, there is no need to transfer a signal to the MME included in the core network arranged in the station building. Thus, by including a function (MME and HSS in the case of LTE) of a core network necessary for an attach procedure in the RRH 100, further low latency can be realized.

In a case where one CC includes a plurality of band width parts (BWPs), if processing of a BWP that requires low latency is processed by the BBU 200 in the station building on the cloud side, a demand for latency cannot be satisfied in some cases.

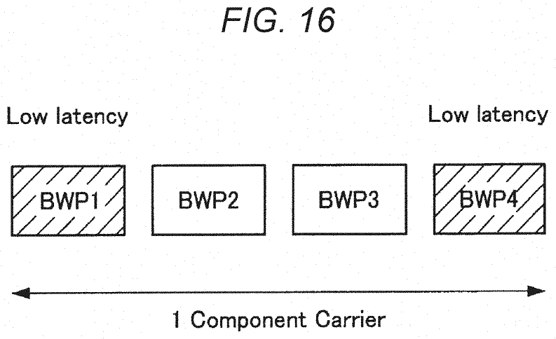

In view of the foregoing, in the present embodiment, information indicating a BWP that can realize low latency is notified from the base station to the UE as System Information or dedicated signaling. FIG. 16 is an explanatory diagram illustrating an example in which four BWPs are included in one component carrier. In this example, because BWP1 and BWP4 are BWPs that can implement low latency, information regarding the BWPs is notified from the base station to the UE as System Information or dedicated signaling.

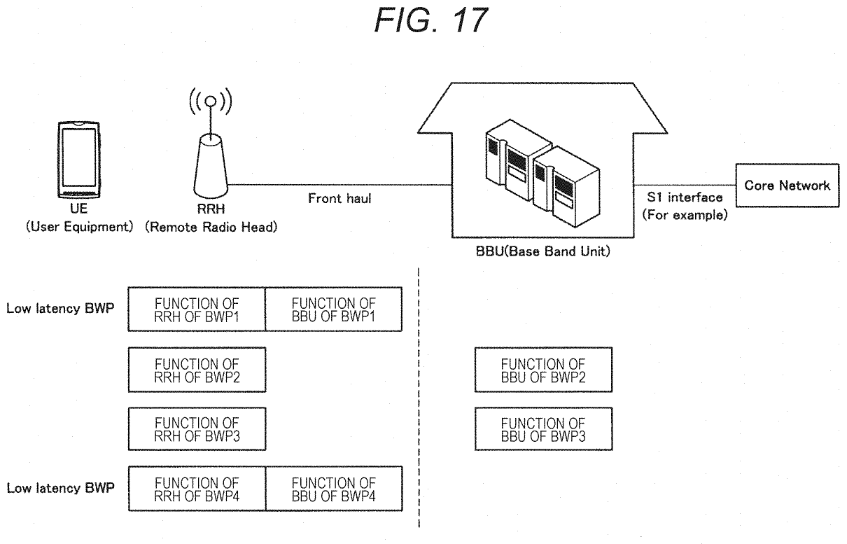

FIG. 17 is an explanatory diagram illustrating a configuration example of a base station according to the present embodiment. As illustrated in FIG. 17, a characteristic lies in that only functions of the BBU that correspond to BWP1 and BWP4 that realize low latency are arranged on the RRH 100 side.

When the BBU 200 is provided on the cloud side, latency increases, and in a case where the number of antennas of the RRH is large, it is necessary to transfer signals by the number corresponding to the number of antennas from the RRH to the BBU. Thus, the BBU needs to perform signal processing on the signals corresponding to the number of antennas, and it is necessary to cope with a capacity increase on an optical line and latency.

In a case where a base station is arranged in a building or an office, because a distance between the base station and a terminal is short, beam forming that uses a number of antennas is not always required for communication. In a case where throughput is to be increased, a number of antennas becomes necessary, but in a case where low latency is preferred because throughput of only several tens of Mbps is sufficient, a C-RAN configuration of transmitting I/Q bit data corresponding to the number of antennas from an RRH to a BBU via an optical fiber is not an appropriate configuration.

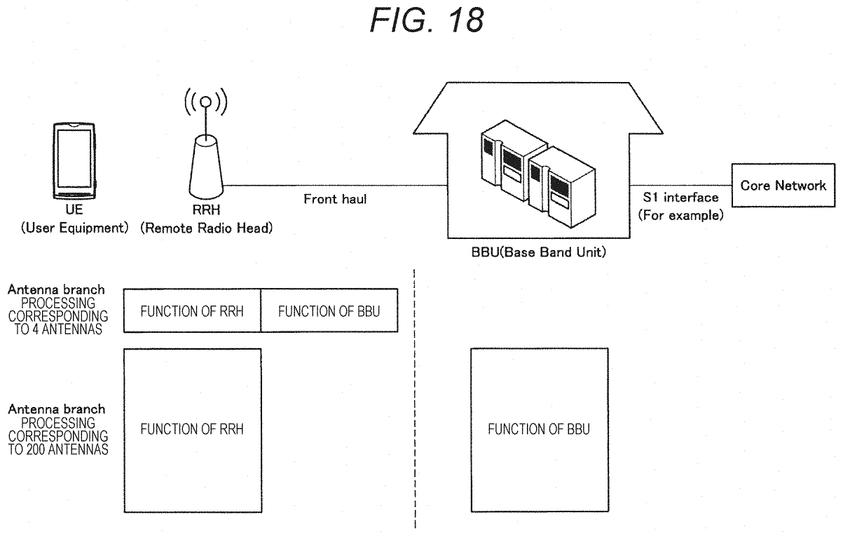

In view of the foregoing, in the present embodiment, in the case of a bearer requiring low latency, a configuration of moving a function of a BBU to an RRH side instead of using a small number of antennas in the base station becomes possible. FIG. 18 is an explanatory diagram illustrating a configuration example of a base station according to the present embodiment. In a case where the base station employs the configuration in FIG. 18, when low latency four antennas are selected will be described.

A first method is a method in which a base station uses only four antennas in a low latency CC or a low latency BWP. In this case, it is desirable that the base station preliminarily notifies the UE that only four antennas are used in a low latency CC or a low latency BWP, as System Information or dedicated signaling.

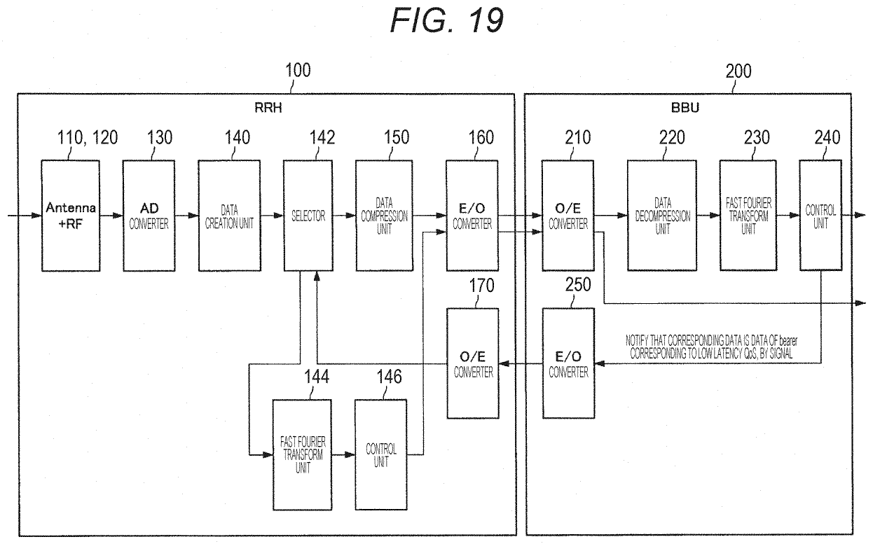

A second method is a method of associating with QoS. For example, the second method is a method of causing a bearer with low latency QoS to use four antennas. In this case, after a bearer is created in compliance with a procedure of bearer establishment of normal LTE, when an uplink signal corresponding to the bearer arrives, signals are guided to a path for processing signals of four antennas. However, because an RRH normally cannot identify the type of received data, whether or not an I/Q bit stream being received is data for low latency is notified from the BBU by an enable signal. FIG. 19 is an explanatory diagram illustrating an example of notifying an enable signal from the BBU 200 to the RRH 100.

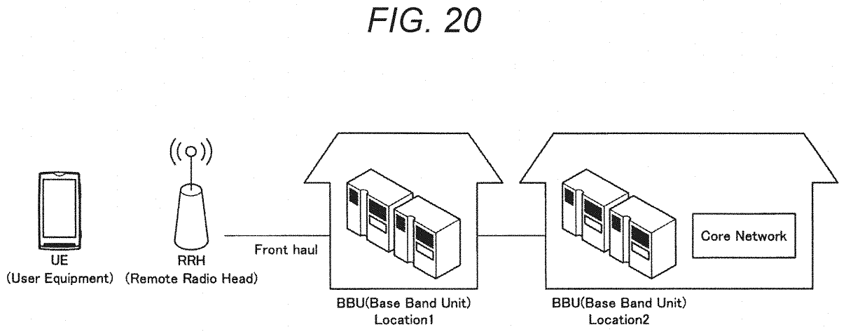

As described above, in the present embodiment, the BBU is arranged on a server existing at an arbitrary location on the Internet that is called a cloud. Then, the BBU is arranged on the server on a network using a virtualization technology such as a virtual machine. FIG. 20 is an explanatory diagram illustrating an arrangement example of an RRH and a BBU. Thus, the arrangement location of the BBU can be changed each time a connection request is received from the RRH.

In a C-RAN including many RRHs, and BBUs accommodating the many RRHs, in a case where one BBU is caused to accommodate a larger number of RRHs, the BBU is sometimes arranged at a location far from a certain RRH.

In a case where a request for an operation of a low latency application is received from an RRH, by arranging a BBU corresponding to the RRH on the edge side of the network, it becomes possible to appropriately provide a service of the BBU to the RRH having a low latency request. However, the level of latency to be realized by each RRH has depended on an application used by a UE connected to the RRH.

In view of the foregoing, in the present embodiment, when an RRH issues a connection request to a BBU in connecting to a network for the first time, the RRH transmits a request for latency to a BBU arrangement management function on the core network side. If the RRH transmits the request for latency to the BBU arrangement management function on the core network side, the BBU arrangement management function arranges the BBU at an appropriate location, and then notifies an IP address of the BBU to the RRH.

The RRH issues a connection request to the BBU having the notified IP address. The BBU gives a permission for connection in response to the connection request from the RRH. The request for latency is notified in two bits, for example, using an indicator from 0 to 3. The notification is issued with being included in an RRH-BBU setup request. Furthermore, the notification is issued by connecting the RRH to the Internet after the user sets the RRH. The indicator can be set as follows, for example.

0: request for latency is very large

1: request for latency is large

2: request for latency is small

3: Any level of latency is allowed (connect only to terminal of MTC)

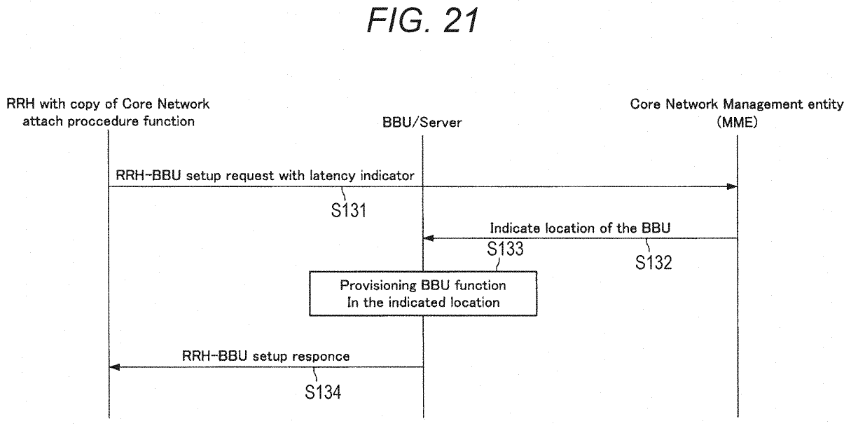

FIG. 21 is a flowchart illustrating an operation example of a base station according to an embodiment of the present disclosure. The RRH transmits a request for connection to the BBU as an RRH-BBU setup request toward an IP address of a control station of a core network that is preset as a default value (Step S131).

The control station of the core network refers to a latency indicator included in the RRH-BBU setup request. As a result of reference, in a case where a request for latency is large, the control station controls the BBU to be arranged close to the UE as far as possible. The decided arrangement is transmitted from the control station to a corresponding server (Step S132). Furthermore, at this time, the control station also notifies an IP address of the RRH together.

If the server provisions the function of the BBU using a virtual machine or the like (Step S133), the server subsequently returns the RRH-BBU setup response for notifying the corresponding RRH that the BBU has been properly provisioned (Step S134).

By arranging the BBU in this manner, for example, in a case where low latency traffic is generated during the operation of the RRH, the RRH can also issue a request for arrangement of the BBU as close as possible, to the core network.

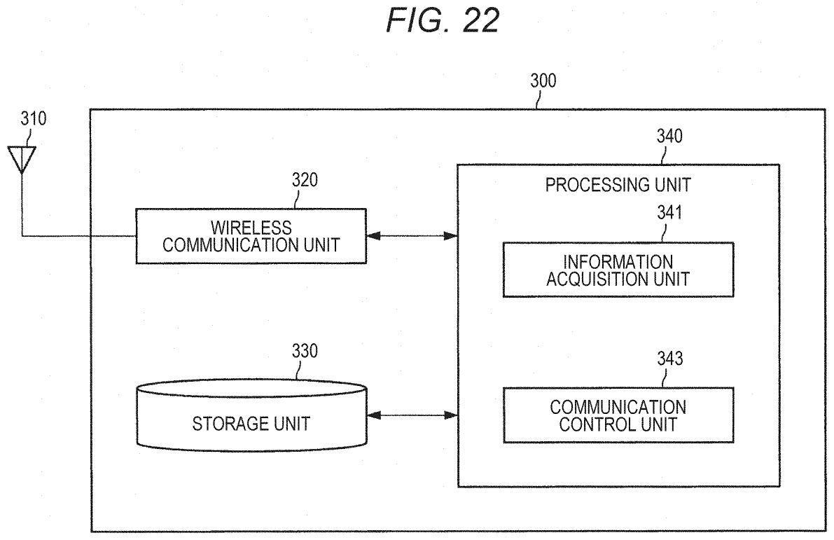

Next, an example of a configuration of a terminal apparatus 300 according to an embodiment of the present disclosure will be described with reference to FIG. 22. FIG. 22 is a block diagram illustrating an example of a configuration of the terminal apparatus 300 according to an embodiment of the present disclosure. Referring to FIG. 22, the terminal apparatus 300 includes an antenna unit 310, a wireless communication unit 320, a storage unit 330, and a processing unit 340.

(Antenna Unit 310)

The antenna unit 310 emits a signal output by the wireless communication unit 320 to a space as radiowaves. Furthermore, the antenna unit 310 converts radiowaves in the space into a signal, and outputs the signal to the wireless communication unit 320.

(Wireless Communication Unit 320)

The wireless communication unit 320 transmits and receives signals. For example, the wireless communication unit 320 receives a downlink signal from the RRH 100, and transmits an uplink signal to the RRH 100.

(Storage Unit 330)

The storage unit 330 stores programs and data for an operation of the terminal apparatus 300.

(Processing Unit 340)

The processing unit 340 provides various functions of the terminal apparatus 300. The processing unit 340 includes an information acquisition unit 341 and a communication control unit 343. Note that the processing unit 340 can include other components other than these components. In other words, the processing unit 340 can perform operations other than operations of these components.

In the present embodiment, the communication control unit 343 performs measurement of a component carrier or selects a component carrier on the basis of information notified from the RRH 100 and acquired by the information acquisition unit 341. More specifically, the communication control unit 343 executes the processing illustrated in Steps S116 and S117 of FIG. 14. By performing such selection, the RRH 100 can promptly execute processing on the component carrier selected by the terminal apparatus 300, and suppress processing latency.

<2. Conclusion>

By applying the present embodiment, it becomes possible for an operator or a user to arrange low-cost base stations at various locations. Furthermore, by prompting effective utilization of frequency, an operator can provide the user with a service under a stable low-cost wireless communication environment. Then, it becomes possible for the user to receive a service under a stable low-cost wireless communication environment.

Steps in the processing executed by each device in this specification need not be always processed chronologically along an order described as a sequence chart or a flowchart. For example, steps in the processing executed by each device may be processed in an order different from the order described as a flowchart, or may be concurrently processed.

Furthermore, a computer program for causing hardware such as a CPU, a ROM, and a RAM that is incorporated in each device, to fulfill a function equivalent to the above-described configuration of each apparatus can also be created. Furthermore, storage medium storing the computer program can also be provided. Furthermore, by forming each function block illustrated in the functional block diagram, by hardware, a series or processes can also be implemented by the hardware.

Heretofore, a preferred embodiment of the present disclosure has been described in detail with reference to the attached drawings, but the technical scope of the present disclosure is not limited to this example. It should be appreciated that a person who has general knowledge in the technical field of the present disclosure can conceive various change examples and modified examples within the scope of the technical idea described in the appended claims, and these change examples and modified examples are construed as naturally falling within the technical scope of the present disclosure.

Furthermore, the effects described in this specification are merely provided as explanatory or exemplary effects, and the effects are not limited. That is, the technology according to the present disclosure can bring about another effect obvious for the one skilled in the art, from the description in this specification, in addition to the above-described effects or in place of the above-described effects.

Note that the following configurations also fall within the technical scope of the present disclosure.

(1) A wireless communication apparatus including:

a wireless communication unit including antenna elements;

a processing unit configured to execute signal processing on partial data of signals output from the antenna elements, preferentially to other data; and

an output unit configured to output the signal processed data to an apparatus on a core network side.

(2) The wireless communication apparatus according to (1) described above, in which the partial data is data of a part of component carriers.

(3) The wireless communication apparatus according to (2) described above, in which the part of component carriers is a primary component carrier.

(4) The wireless communication apparatus according to any of (1) to (3) described above, in which the partial data is data required to be subjected to the signal processing with low latency.

(5) The wireless communication apparatus according to any of (1) to (4) described above, in which the processing unit executes fast Fourier transform processing on the partial data.

(6) The wireless communication apparatus according to (5) described above, in which the processing unit executes decoding processing on the partial data having been subjected to fast Fourier transform processing.

(7) The wireless communication apparatus according to any of (1) to (6) described above, further including an acquisition unit configured to acquire a control signal in the signal processing from the apparatus.

(8) The wireless communication apparatus according to (7) described above, in which the acquisition unit acquires information regarding designation of data to be subjected to the signal processing in the processing unit.

(9) The wireless communication apparatus according to (8) described above, in which the acquisition unit acquires information regarding designation of a component carrier to be subjected to the signal processing in the processing unit.

(10) The wireless communication apparatus according to any of (1) to (9) described above, in which the output unit outputs a request regarding latency in issuing a connection request to an apparatus on the core network side.

(11) The wireless communication apparatus according to any of (1) to (10) described above, in which the wireless communication unit transmits information regarding a carrier corresponding to the partial data, to a communication partner apparatus.

(12) A wireless communication apparatus including:

a reception unit configured to receive information regarding partial data to be preferentially processed by the wireless communication apparatus, from a communication partner wireless communication apparatus; and

a processing unit configured to select a component carrier on the basis of the information regarding the partial data.

(13) A communication control method including:

executing the signal processing on partial data of signals output from antenna elements, preferentially to other data; and

outputting the processed data to an apparatus on a core network side.

(14) A communication control method including:

receiving information regarding partial data to be preferentially processed by the wireless communication apparatus, from a communication partner wireless communication apparatus; and

selecting a component carrier on the basis of the received information regarding the partial data.

### REFERENCE SIGNS LIST

### 100 RRH

### 200 BBU

300 Terminal apparatus

1. A wireless communication apparatus comprising:
a wireless communication unit including antenna elements;
a processing unit configured to execute signal processing on partial data of signals output from the antenna elements, preferentially to other data; and
an output unit configured to output the signal processed data to an apparatus on a core network side.

2. The wireless communication apparatus according to claim 1, wherein the partial data is data of a part of component carriers.

3. The wireless communication apparatus according to claim 2, wherein the part of component carriers is a primary component carrier.

4. The wireless communication apparatus according to claim 1, wherein the partial data is data required to be subjected to the signal processing with low latency.

5. The wireless communication apparatus according to claim 1, wherein the processing unit executes fast Fourier transform processing on the partial data.

6. The wireless communication apparatus according to claim 5, wherein the processing unit executes decoding processing on the partial data having been subjected to fast Fourier transform processing.

7. The wireless communication apparatus according to claim 1, further comprising an acquisition unit configured to acquire a control signal in the signal processing from the apparatus.

8. The wireless communication apparatus according to claim 7, wherein the acquisition unit acquires information regarding designation of data to be subjected to the signal processing in the processing unit.

9. The wireless communication apparatus according to claim 8, wherein the acquisition unit acquires information regarding designation of a component carrier to be subjected to the signal processing in the processing unit.

10. The wireless communication apparatus according to claim 1, wherein the output unit outputs a request regarding latency in issuing a connection request to an apparatus on the core network side.

11. The wireless communication apparatus according to claim 1, wherein the wireless communication unit transmits information regarding a carrier corresponding to the partial data, to a communication partner apparatus.

12. A wireless communication apparatus comprising:
a reception unit configured to receive information regarding partial data to be preferentially processed by the wireless communication apparatus, from a communication partner wireless communication apparatus; and
a processing unit configured to select a component carrier on a basis of the information regarding the partial data.

13. A communication control method comprising:
executing the signal processing on partial data of signals output from antenna elements, preferentially to other data; and
outputting the signal processed data to an apparatus on a core network side.

14. A communication control method comprising:
receiving information regarding partial data to be preferentially processed by the wireless communication apparatus, from a communication partner wireless communication apparatus; and
selecting a component carrier on a basis of the received information regarding the partial data.
